(19) United States
(12) Patent Application Publication
(10) Pub. No.: US 2014/0261719 A1
(43) Pub. Date: Sep. 18, 2014

(54) SYSTEM AND METHOD FOR REGULATING A CONSTANT POSITIVE PRESSURE DIFFERENTIAL WITHIN A CONTAINER

(71) Applicant: Richard Todd Onysko, San Antonio, TX (US)

(72) Inventor: Richard Todd Onysko, San Antonio, TX (US)

(21) Appl. No.: 14/210,690

(22) Filed: Mar. 14, 2014

Related U.S. Application Data
(60) Provisional application No. 61/786,689, filed on Mar. 15, 2013.

(51) Int. Cl. G05D 16/20

(52) U.S. Cl. CPC G05D 16/2006
USPC 137/12; 137/485

(57) ABSTRACT

A system and method for regulating a constant positive pressure differential within a container in order to maintain the waterproof integrity of the container. In one embodiment, the system for regulating a constant positive pressure differential within a container is comprised of a valve member, a control member, and an air supply member. In another embodiment, the system for regulating a constant positive pressure differential within a container is also comprised of a container member.

### CROSS-REFERENCE TO RELATED APPLICATIONS

This application claims the benefit under Title 35 United States Code §119(e) of U.S. Provisional Patent Application Ser. No. 61/786,689; Filed: Mar. 15, 2013, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a system and method directed to maintaining the waterproof integrity of a container. More specifically, the present invention relates to a system and method for regulating a constant positive pressure differential within a container in order to maintain the waterproof integrity of a container.

### BACKGROUND OF THE INVENTION

Without limiting the scope of the disclosed system and method, the background is described in connection with a novel system and approach directed to regulation of a constant positive pressure differential within a container in order to maintain the waterproof integrity of a container.

Currently, in water environments, sensitive equipment is protected from exposure by encasements that are waterproof. For example, underwater cameras are housed in waterproof shells that prevent water from ever reaching the camera. These waterproof containers often employ seals of some sort such as silicone seals. This has been the state of the art for quite some time and is the conventional method of protecting items from exposure to water. This is a passive approach of keeping water from entering these containers.

One of the major issues with this conventional approach of utilizing seals to provide the waterproof protection is that over time the seals begin to fail. As the seals begin to fail, the waterproof integrity of the container is compromised and leaks begin to manifest. Depending on the type of seal failure, exposure of the item encased in the container to water may be minimal or catastrophic. In the case of underwater cameras, expensive equipment can be damaged as well as the data stored on the device.

Presently, it seems to be an accepted risk that the seals might leak or fail. This risk is currently managed by careful maintenance and/or replacement of failing seals. This approach has been utilized for quite some time.

While all of the aforementioned approaches may fulfill their unique purposes, none of them fulfill the need for a practical and effective means for maintaining the waterproof integrity of a container.

The present invention therefore proposes a novel system and method for regulating a constant positive pressure differential within a container in order to maintain the waterproof integrity of a container.

### BRIEF SUMMARY OF THE INVENTION

The present invention, therefore, provides for a system and method for regulating a constant positive pressure differential within a container in order to maintain the waterproof integrity of a container.

In one embodiment, the system for regulating a constant positive pressure differential within a container is comprised of a valve member, a control member, and an air supply member. In another embodiment, the system for regulating a constant positive pressure differential within a container is also comprised of a container member. A positive pressure differential within a container is achieved when the air or gas pressure within the container is higher than the air or gas pressure outside of the container. Maintaining this positive pressure differential is desired in order to assist in identifying failed or damaged seals. Instead of a passive method of having the seals fail and begin to leak thereby causing damage to expensive equipment being housed in the waterproof encasements, the positive pressure differential would reveal a faulty seal through escaping gas bubbles. This prevents water or any other fluid from entering the waterproof encasement or container and allowing the user of the system to identify the faulty seal.

In summary, the present invention discloses an improved system and method of use directed to maintaining the waterproof integrity of a container. More specifically, the present invention relates to a system and method for regulating a constant positive pressure differential within a container in order to maintain the waterproof integrity of a container.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a front perspective view of the system for regulating a constant positive pressure differential within a container in accordance with embodiments of the disclosure;

FIG. 2 is a left side view of the system for regulating a constant positive pressure differential within a container in accordance with embodiments of the disclosure;

FIG. 3 is a rear perspective view of the system for regulating a constant positive pressure differential within a container in accordance with embodiments of the disclosure;

FIG. 4 is a rear close-up view of the system for regulating a constant positive pressure differential within a container in accordance with embodiments of the disclosure.

### DETAILED DESCRIPTION OF THE INVENTION

Disclosed herein is an improved system and method for regulating a constant positive pressure differential within a container in order to maintain the waterproof integrity of a container. The numerous innovative teachings of the present invention will be described with particular reference to several embodiments (by way of example, and not of limitation).

Reference is first made to FIG. 1, a front perspective view of the system for regulating a constant positive pressure differential within a container in accordance with embodiments of the disclosure. In one embodiment, the system for regulating a constant positive pressure differential within a container is comprised of a valve member 20, a control member 30, and an air supply member 40. The valve member 20 allows the release and introduction of air into the container member 10 to maintain or regulate the air pressure within the container member 10. In an embodiment, the system may have multiple valve members 20, with one or more allowing the introduction of gas into the container and one or more allowing the release of gas from the container. Regulation of air pressure is achieved by the introduction of air or a gas into the container member 10 or the release of gas from the container member 10. The valve member 20 is coupled or connected to the container member and the control member 30. The control member 30 has the means of obtaining pressure readings inside the container member 10 and outside the container member 10 via pressure sensors. In addition, the control member 30 has the means of controlling the valve member 20 and the air supply member 40. That is, the control member 30 has the means to operate the valve member 10 in order to release air from the container member 10 in order to decrease pressure within the container member 10, or introduce air from the air supply member 40 into the container member 10 in order to increase pressure within the container member 10. The control member 30 is connected to the valve member 20 and may also be connected to the air supply member 40 as depicted. These connection or coupling may be achieved through physical connections such as but not limited to adhesives, screws, wiring, and threading or non-physical connections such as but not limited to wireless connectivity. The control member 30 also has the means of recording, storing, and displaying the pressure readings along with controls to maintain a set pressure difference between the inside and outside of the container member 10. A CPU, chip memory, required software, and a display/control screen may supply the means. The user of the system can set a defined pressure difference and the system will maintain that defined pressure difference regardless of changing pressure outside the container member 10. The air supply member 40 has the means to store air or a gas within itself and supply air into the container member 10 for the purpose of increasing the pressure within the container member 20. The air supply member may be an air tank, portable compressed gas/air cartridge, SCUBA equipment, system for pulling air from the external environment if operating above water, an extraction system for obtaining gas directly from a liquid environment such as through a chemical process such as electrolysis, etc. In another embodiment, the system for regulating a constant positive pressure differential within a container is also comprised of a container member 10.

The system for regulating a constant positive pressure differential within a container maintains a positive or higher pressure within the container member 10 relative to the pressure outside the container member 10. This is to prevent water from entering the container member 10 when seals begin to fail. Instead of water starting to leak into the container member 10 where the seals are failing, because of the positive or increased pressure within the container member 10, air bubbles will exit from the container member 10 at those failed sealed locations. This system, in conjunction with any otherwise waterproof container, provides a means of active rather than passive, water repelling from the interior of the container member 10.

The system adds an additional active approach of preventing water from entering containers through the use of a constant positive pressure differential, regulated in reaction to changes in pressure outside the container member 10.

Reference is next made to FIG. 2, a left side view of the system for regulating a constant positive pressure differential within a container in accordance with embodiments of the disclosure. In this illustration the valve member 20 can be seen partially inside the container member 10 and attached, extending outside of the container member 20 and partially into the control member 30 and attached.

Reference is now made to FIG. 3, a rear perspective view of the system for regulating a constant positive pressure differential within a container in accordance with embodiments of the disclosure. In this illustration the control member 30 can be seen more clearly. In this view, the control member 30 can be seen with a flat surface for a possible display panel to house controls for setting the desired pressure differential to be maintained within and outside the container member 10 and also displaying measurement readings such as pressure within and outside the container member 10.

Reference is lastly made to FIG. 4, a rear close-up view of the system for regulating a constant positive pressure differential within a container in accordance with embodiments of the disclosure. In this view, how the members are connected can be seen. In this embodiment, the control member 30 forms connections with the valve member 20 and the air supply member 40.

In brief, as described herein provides for an effective and efficient regulation of a constant positive pressure differential within a container in order to maintain the waterproof integrity of a container.

The disclosed system and method is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed system or method, except as may be outlined in the claims.

Alternative applications for this invention include using this system and method for maintaining the integrity of a fluid or gas within a container from that of the fluid or gas outside of the container. Consequently, any embodiments comprising a one piece or multi piece system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific system and method described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A system for regulating a constant positive pressure differential within a container comprising:
a container member;
a valve member coupled to said container member and configured to regulate the gas pressure within said container member;
an air supply member coupled to said valve member and configured to supply a gas inside said container member;
a control member communicatively coupled with said valve member and said air supply member and configured for controlling said valve member and said air supply member.

2. The system of claim 1, wherein said gas is air.

3. The system of claim 1, wherein said container member is a waterproof camera shell.

4. The system of claim 1, wherein said air supply member is a compressed air cartridge.

5. The system of claim 1, wherein said air supply member is a SCUBA tank.

6. The system of claim 1, wherein said air supply member is an air tank.

7. The system of claim 1, wherein said air supply member is an extraction system for obtaining gas directly from a liquid environment.

8. The system of claim 1, wherein said air supply member is a system for pulling air from the external environment if operating above water.

9. The system of claim 1, wherein said control member also comprises a pressure sensor configured to obtain pressure readings within said container.

10. The system of claim 1, wherein said control member also comprises pressure sensors configured to obtain pressure readings within said container and the external environment.

11. The system of claim 1, wherein said control member is also comprised of user controls for recording, storing, and displaying the pressure readings as well as user controls for setting the pressure difference to be maintained between the inside and outside of said container member.

12. The system of claim 1, wherein said control member is also comprised of user display interface for user controls.

13. A method for regulating a constant positive pressure differential within a container comprising the steps of:
setting the positive pressure difference to be maintained between the gas inside of the container member and the environment outside of the container member;
receive inside and outside pressure readings of said container member from the control member sensors;
compare the set positive pressure difference to be maintained with the sensor pressure measured difference;
adjust said container member's inside pressure if necessary, to maintain set positive pressure difference.

14. The method of claim 13, wherein said gas is air.

15. The method of claim 13, wherein said container member is a waterproof camera shell.

16. The method of claim 13, wherein said air supply member is a compressed air cartridge.

17. The method of claim 13, wherein said air supply member is a SCUBA tank.

18. The method of claim 13, wherein said air supply member is an air tank.

19. The method of claim 13, wherein said air supply member is an extraction system for obtaining gas directly from a liquid environment.

20. The method of claim 13, wherein said air supply member is a system for pulling air from the external environment if operating above water.
